(19) United States
(12) Patent Application Publication
(10) Pub. No.: US 2009/0066654 A1
(43) Pub. Date: Mar. 12, 2009

(54) MULTI ORIENTATION USER INTERFACE AND ELECTRONIC DEVICE WITH SAME

(75) Inventors: WEI-JEN WANG, Tu-Cheng (TW); SHIH-PAO CHENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/964,773

(22) Filed: Dec. 27, 2007

(30) Foreign Application Priority Data
Sep. 11, 2007 (CN) 200710201650.2

(51) Int. Cl. G06F 3/02; G09G 5/00; G06F 3/041

(52) U.S. Cl. 345/169; 345/156; 345/173

(57) ABSTRACT

An exemplary multi orientation user interface for use in a portable electronic device includes a keypad, an orientation sensor, and a processor. The keypad includes a number of keys each associated with a respective command configured to command the portable electronic device to perform a corresponding function. The orientation sensor is configured to detect an orientation of the portable electronic device. The processor is configured to reorient the keys so that the keypad is friendly to a user in the detected orientation of the portable electronic device.

### BACKGROUND

1. Technical Field

The invention relates to a user interface of an electronic device and, in particular, relates to a multi orientation user interface and an electronic device using same.

2. Description of Related Art

Most electronic devices are allowed to be used in different orientations, for example, digital still cameras (DSCs) are commonly allowed to be used in a horizontal/level orientation (including a normal orientation and upside-down orientation) to create a landscape type image having a larger width dimension than height dimension, or in a vertical/sideways orientation (including a 90° clockwise orientation and a 90° counterclockwise orientation) to create a portrait type image having a larger height dimension as compared to the width dimension. However, these electronic devices generally have a user interface (typically including a display for output and a keypad for input) being friendly to a user only in one predetermined orientation, e.g., the normal orientation.

Therefore, it is desirable to provide a multi orientation user interface and an electric device with the same, which can overcome the abovementioned problem.

### SUMMARY

In a present embodiment, a multi orientation user interface for use in a portable electronic device includes a keypad, an orientation sensor, and a processor. The keypad includes a number of keys each associated with a respective command configured to command the portable electronic device to perform a corresponding function. The orientation sensor is configured to detect an orientation of the portable electronic device. The processor is configured to reorient the keys so that the keypad is friendly to a user in the detected orientation of the portable electronic device.

### BRIEF DESCRIPTION OF THE DRAWINGS

Many aspects of the present multi orientation user interface and electronic device should be better understood with reference to the following drawings. The components in the drawings are not necessarily drawn to scale, the emphasis instead being placed upon clearly illustrating the principles of the present multi orientation user interface and electronic device. Moreover, in the drawings, like reference numerals designate corresponding parts throughout the several views.

FIG. 1 is schematic, rear view of a digital still camera (DSC) held in a first orientation, according to an exemplary embodiment.

FIG. 2 is a functional view of the DSC of FIG. 1.

FIG. 3 is a schematic, rear view of the DSC of FIG. 1 held in a second orientation.

FIG. 4 is a schematic, rear view of the DSC of FIG. 1 held in a third orientation.

FIG. 5 is schematic rear view of the DSC of FIG. 1 held in a fourth orientation.

### DETAILED DESCRIPTION OF THE EMBODIMENTS

Embodiments of the present multi orientation user interface and electronic device will now be described in detail with reference to the drawings. In these described embodiments, such an electronic device is, for example, a digital still camera (DSC). But it should be understood that the electronic device should be read broadly, and can be but not limited to: a portable communication device such as cellular phone or pager, a portable computing device such as personal digital assistant, laptop computer, or thin client controller, or a personal entertainment device such as gaming device, media player (including audio and/or video player), or imaging device (such as video camera).

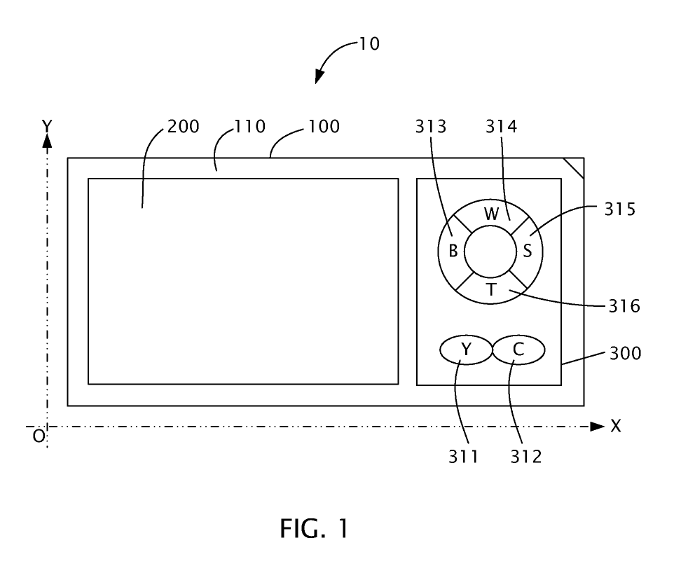

Referring to FIG. 1, a DSC 10 in accordance with an embodiment includes a housing 100 configured to hold/accommodate components of the DSC 10 such as a lens module, an image sensor, or an image signal processing module, a display 200 such as a liquid crystal display, a plasma display, a light emitting diode display, or an organic light emitting diode display, mounted in the rear surface 110 of the housing 100 and configured to show an image captured by the image sensor and/or information of the DSC 10 (e.g., mode or status), and a keypad 300 provided on the rear surface 110 of the housing 100. The keypad 300 forms a number of keys, e.g., ‘W’, ‘T’ ‘B’ ‘S’ ‘Y’ ‘C’, each of which is associated with a respective command configured to trigger the DSC 10 to perform a corresponding functionality, e.g., zoom in/out (key ‘T’/‘W’), or yes/cancel (key ‘Y’/‘C’). It is to be noted that though a layout of the keypad 300 with a direction key (T/W/B/S) and two individual keys (Y/C) is shown, the actual keypad is not limited to this embodiment but could conform to other layouts with a corresponding group of commands.

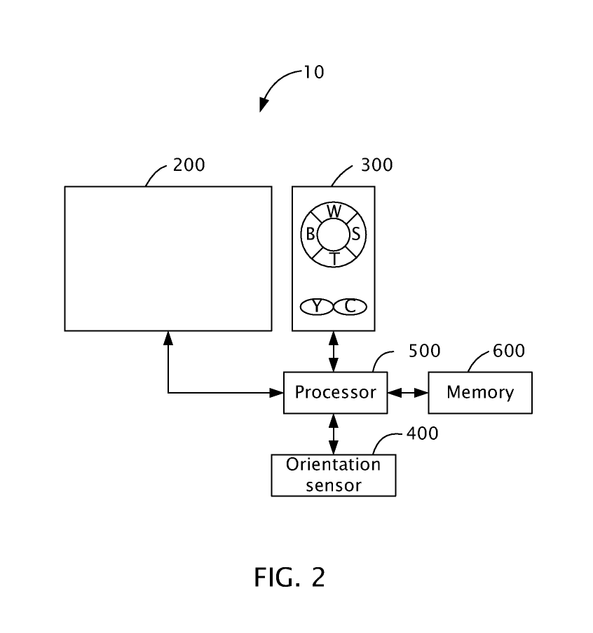

Also referring to FIG. 2, in addition to the housing 100, the display 200, and the keypad 300, the DSC 10 further includes an orientation sensor 400 fixedly accommodated in the housing 100 and configured to detect a current orientation of the DSC 10, and a processor 500 coupled to the display 200, the keypad 300, the orientation sensor 400, and other components of the DSC 10 that need to be communicated with the processor 500 (e.g., the lens module, the image sensor, and the image signal processing module), and configured to reorient the keys W, T, B, S, Y, C, so that the keypad 300 is friendly to a user in the detected orientation of the DSC 10.

In this embodiment, the keypad 300 is provided by a touch screen 310. The touch screen 310 should be read broadly to encompass any components or group of interrelated components that provide a touchable display configured to show representations (e.g., the character W, T, B, S, Y, and C) in a number of sensing locations (e.g., sensing locations 311˜316, see FIG. 1) defined in the screen of the touchable display and associated with the keys to indicate the functionality of the keys W, T, B, S, Y, and C, and one or more sensors configured to identify which location is touched (e.g., pressed on, pressed on and released, or moved across) and coupled to the processor 500 to instruct the processor 500 to respond to the touching of the location. It is to be noted that though only one touch screen is described, the actual keypad can be provided by more than one touch screen (e.g., each key is provided a unique touch screen). It also should be noted that the touchable display can be a liquid crystal display, a plasma display, a light emitting diode display, or an organic light emitting diode display.

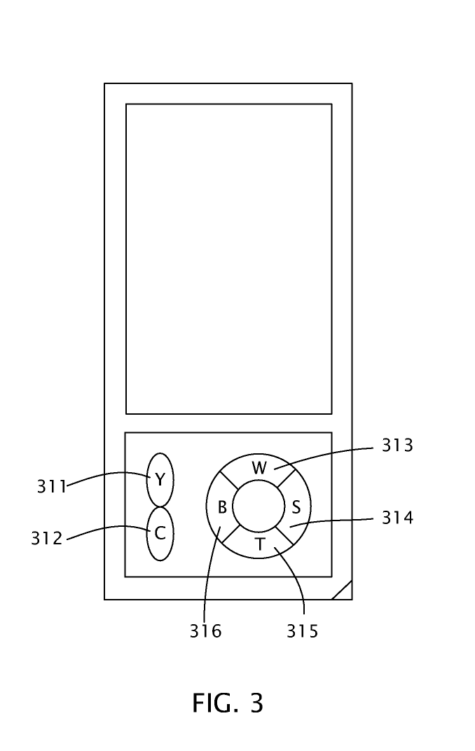

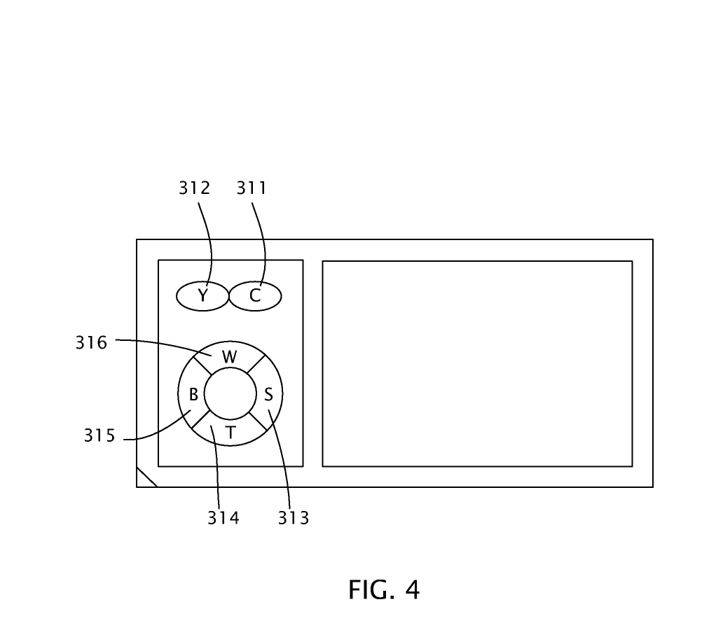

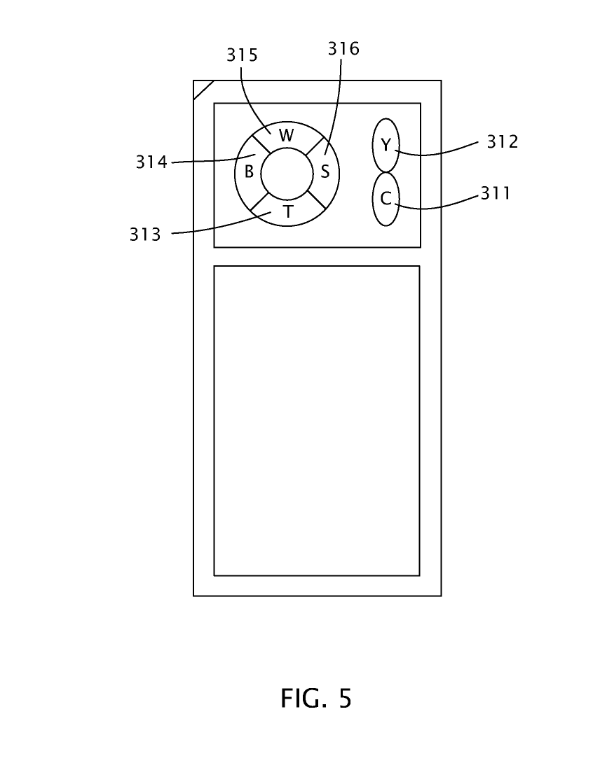

The orientation sensor 400 is opportunely configured to detect the orientation about two orthogonal axes ‘X’ and ‘Y’ (see FIG. 1), for determining relative orientation of the DSC 10 such as e.g. normal, 90° clockwise (see FIG. 3), upside-down (see FIG. 4), and 90° counterclockwise (see FIG. 5), the DSC 10 is in. It should be noted that various types of automatic orientation sensors can be used, such as mercury switches, self-orienting switches, optical sensors, and gyroscopic devices. In practice, a signal of the orientation sensor 400 is sent to the processor 500 (or the processor 500 reads the signal), and is analyzed by the processor 500 to determine the orientation of the DSC 10. It should be considered that a user may not hold the DSC perfectly in the normal, upside-down, 90° clockwise, or 90° counterclockwise orientation. So, the processor 500 should be capable of determining the orientation of the DSC 10 when the DSC 10 is not perfectly held in the above four orientations so as to ensure correct reorientation of the keys W, T, B, S, Y, C.

The processor 500 is configured to respond to rotating of the DSC 10 (instructed by the orientation sensor 400) and reorient the keys W, T, B, S, Y, and C (that is, the processor 500 reorients the keys corresponding to the sensing locations 311˜316 to appear in a same upright pattern as viewed by the user). In practice, the DSC 10 commonly includes a memory 600. The memory 600 maintains software instructions which, when executed by the processor 500, allow the DSC 10 to perform various functions, e.g., responding to the rotating of the DSC 10 and reorienting the keys W, T, B, S, Y, and C. In this embodiment, these software instructions also include four groups of associations (in a form of, e.g., table) between the sensing locations 311˜316 and the commands corresponding to the keys W, T, B, S, Y, and C, so the processor 500 can interchange the commands of the keys W, T, B, S, Y, and C by executing the instruction including the respective group of association ships, according to the signal of the orientation sensor 400. Understandably, these groups of associations can be predetermined according to user preferences or recommendations of the manufacturer, and not be limited to those shown in FIGS. 1, 3˜5. The processor 500 is preferably programmed to ignore quick changes in detected orientation of DSC 10 so as to avoid inadvertent quick repetitive changes to the keypad 300.

Furthermore, the orientation sensor 400 can be switched off, via, e.g., the keypad 300, and/or other controls of the DSC 10, and therefore the DSC 10 maintains the keypad 300 in a single desired orientation. This can be advantageous when e.g. traveling in an airplane or train, where the accelerative forces of the moving vehicle could disturb proper operation of the orientation sensor 400.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A multi orientation user interface for use in a portable electronic device comprising:
a keypad comprising a plurality of keys;
an orientation sensor configured to detect an orientation of the portable electronic device; and
a processor configured to reorient the plurality of keys so that the keypad is friendly to a user in the detected orientation of the portable electronic device.

2. The multi orientation user interface as claimed in claim 1, further comprising a touch screen with the keypad provided thereon, wherein the touch screen is configured for selectively showing the keys in a first arrangement or a second arrangement.

3. The multi orientation user interface as claimed in claim 2, wherein the touch screen is configured to show a plurality of representations each configured to indicate the functionality of the respective key.

4. The multi orientation user interface as claimed in claim 2, wherein the touch screen includes a plurality of sensing locations, each of the sensing locations being associated with a respective key displayed on the sensing location.

5. The multi orientation user interface as claimed in claim 4, wherein the processor is configured for rearranging the sensing locations to correspond to the first arrangement of the keys or the second arrangement of the keys.

6. The multi orientation user interface as claimed in claim 4, further comprising a memory, the memory storing software instructions containing a plurality of groups of associations between the plurality of locations and the commands of the plurality of keys, the processor interchanging the commands of the plurality of keys by executing the software instruction including a respective group of association ships according to the detected orientation of the portable electronic device.

7. The multi orientation user interface as claimed in claim 1, wherein the orientation sensor is an automatic sensor selected from a group of: mercury switch, self-orienting switch, optical sensor, and gyroscopic device.

8. The multi orientation user interface as claimed in claim 1, wherein the orientation sensor is configured for detecting following orientations: normal, upside-down, 90° clockwise, and 90° counterclockwise orientation.

9. The multi orientation user interchange as claimed in claim 1, further comprising a display configured to show information.

10. A multi orientation user interface for use in a portable electronic device comprising:
a touch screen providing a plurality of virtual keys;
an orientation sensor configured to detect the orientation of the portable electronic device; and
a processor configured to reorient the plurality of virtual keys in the keypad so that the keypad is friendly to a user in the detected orientation of the portable electronic device.

11. The multi orientation user interface as claimed in claim 10, wherein each virtual key is defined on a location of the screen of the touch screen with showing a respective representation indicative of a corresponding functionality of the portable electronic device.

12. A portable electronic device comprising:
a multi orientation user interface comprising:
a keypad comprising a plurality of keys;
an orientation sensor configured to detect an orientation of the portable electronic device; and
a processor configured to reorient the plurality of keys so that the keypad is friendly to a user in the detected orientation of the portable electronic device.

13. The electronic device as claimed in claim 12, being selected from a group of: cellular phone, pager, personal digital assistant, laptop computer, thin client controller, gaming device, media player, digital still camera, and video camera.

14. The electronic device as claimed in claim 12, further a housing configured to receive the display, the keypad, the orientation sensor, and the processor, the user interface further comprising a display configured to show information.
